(19) United States
(12) Patent Application Publication
(10) Pub. No.: US 2003/0075824 A1
(43) Pub. Date: Apr. 24, 2003

(54) Method for recycling carpet and articles made therefrom

(76) Inventors: Roy E. Moore JR., Killingworth, CT (US); Peter Inch, Lexington, KY (US)

Correspondence Address: CANTOR COLBURN LLP, 55 Griffin Road South, Bloomfield, CT, 06002, US

(21) Appl. No.: 10/279,443

(22) Filed: Oct. 24, 2002

Related U.S. Application Data
(60) Provisional application No. 60/334,900, filed on Oct. 24, 2001.

(51) Int. Cl. B29B 9/00; B29C 49/00

(52) U.S. Cl. 264/143; 264/523; 264/913

(57) ABSTRACT

Disclosed herein are methods for recycling carpet, for making articles with the recycled carpet, and articles made therefrom. In one embodiment, the method for recycling carpet comprises: melting recycle carpet; reducing a water content of the recycle carpet to less than or equal to about 0.5 wt %, based upon the total weight of the recycle carpet and the water, to form a melt ribbon; and forming pellets from the extruded melt ribbon of recycle material.

CROSS REFERENCE TO RELATED APPLICATIONS

This application claims priority to U.S. Serial No. 60/334,900, filed Oct. 24, 2001, the entire contents of which are incorporated herein by reference.

### BACKGROUND OF THE INVENTION

This disclosure relates to making plastic articles, and especially relates to recycling carpet.

The use of synthetic fibers has increased in many areas of technology, including various types of carpeting and other floor covering. Increased production of carpets, however, creates the problem of what to do with used carpet after it exhausts its service life.

Significant effort has been expended on identifying environmentally responsible methods for disposing of flooring material. However, an obstacle to successful recycling of carpet is the fact that carpet is currently manufactured from a number of different synthetic materials that have varying physical and chemical characteristics. For example, conventional carpet materials typically include several layers. The simplest types of carpet might have fibrous pile (e.g., nylon, PET, or polypropylene) fused directly to a thermoplastic, typically polyolefin, backing. There can also be a secondary binder or substrate layer, a reinforcing web material through which the pile is attached, and/or separate glue that is used to anchor the pile to the backing. The glue can be, for example, styrene-butadiene rubber, applied as a latex, filled with an inorganic filler such as calcium carbonate.

Successful attempts at recycling such multi-component products have been severely limited. Efforts have focused on methods for reprocessing fiber-containing waste materials wherein the process results in a fiber-containing final product. However these types of processes are restricted in utility to the limited application where composite (fiber/matrix) materials are useful.

Other recycling approaches have focused on separating out the individual materials for re-use. These methods, while effective in reclaiming individual synthetic materials, are extremely expensive to the extent of often being cost prohibitive. Further, the additional energy required to affect the necessary processing steps at least partially reduces the environmental advantage of recycling or reclaiming.

Additional work needs to be done in the area of recycling carpet to enable cost effective use thereof.

### BRIEF DESCRIPTION OF THE INVENTION

Disclosed herein are methods for recycling carpet, for making articles with the recycled carpet, and articles made therefrom. In one embodiment, the method for recycling carpet comprises: melting recycle carpet; reducing a water content of the recycle carpet to less than or equal to about 0.5 wt %, based upon the total weight of the recycle carpet and the water, to form a melt ribbon; and forming pellets from the extruded melt ribbon.

The above described and other features are exemplified by the following figures and detailed description.

### BRIEF DESCRIPTION OF THE DRAWINGS

Referring now to the figure:

FIG. 1 is a schematic depicting the carpet recycling method.

### DETAILED DESCRIPTION

Recycled carpet can be converted into a material suitable for use, for example, in blow molding, and even for use in injection molding. The carpet can be employed to form various articles, including, but not limited to, leaching chamber(s), e.g., for dispersing liquids in soil, of the type having a hollow interior with open ends and an open bottom enabling passage of liquids therethrough; endplate(s) for use with a leaching chamber for dispersing liquids in soil, of the type having a hollow interior with open ends, and sidewalls with perforations enabling passage of liquids therethrough, and wherein the endplate comprises an inner wall and an outer wall defining a central portion having an interior channel and optionally at least one connector capable of engaging an edge of a leaching chamber, with physical contact with both an inner surface and an outer surface of the leaching chamber; pallets; and the like.

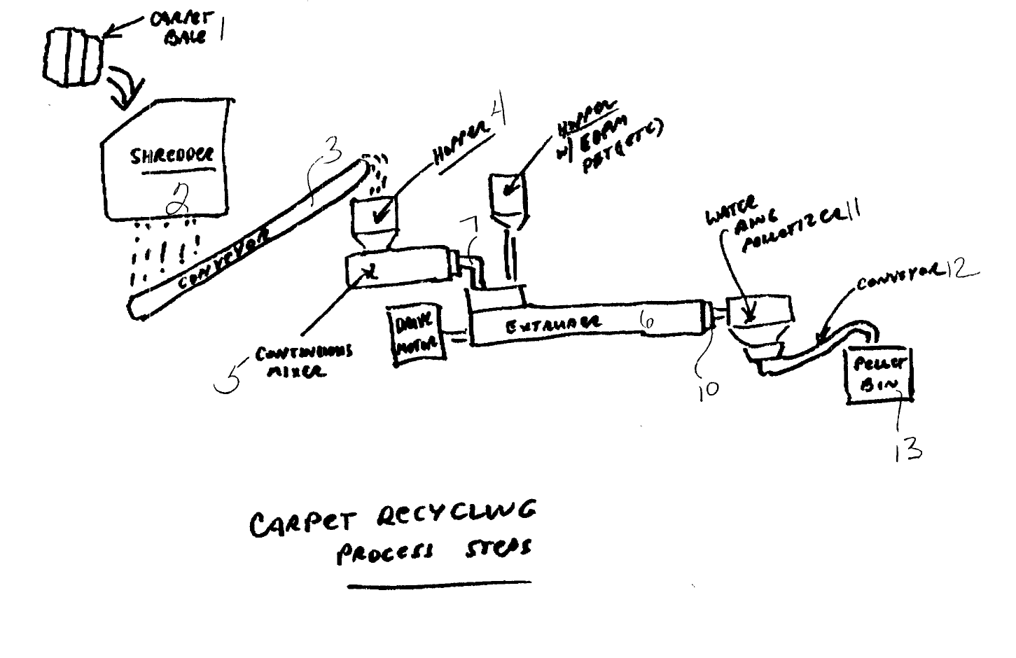

FIG. 1 depicts the overall method and apparatus used to recycle carpet. According to FIG. 1, carpet, typically in the form of a carpet bale 1, is placed in a shredder 2 where the bulk carpet sample is shredded. The resulting carpet strips are then fed from the shredder onto a conveyer 3 that conveys the carpet strips to a continuous mixer 5 via a hopper 4. The continuous mixer 5 melts the carpet strips and reduces any moisture therein to produce a melted carpet. From the continuous mixer 5, the melted carpet passes through a feed throat 7 and into an extrusion device 6. Also introduced to the continuous mixer 5 and/or extrusion device 6 via hopper 8 can be additives capable of adjusting the properties of the melted carpet. Within the continuous mixer 5 and/or extrusion device 6, the melted carpet and additives are further mixed and melted to form a melted material. The melted material then passes to an extruder die head 10 and into a pelletizer 11. The pelletizer 11 creates pellets that pass from the pelletizer 11 via additional conveyer 12 into pellet bin 13 for later use, such as in injection molding.

The carpet can comprise any available main material (e.g., poly(ethylene terephthalate) (PET), polypropylene, nylon carpet, and the like), with any pile weight. Preferably a post-consumer or used carpet is employed for reasons of economy, availability, and environmental considerations; although, non-used carpet, such as carpet unacceptable for sale, trim scrap from production of the carpet, or carpet returned by the purchaser, may also be used. Furthermore, the carpet may be in any number of physical conditions including soiled, wet, dyed, treated for stain resistance, and the like, as well as combinations comprising at least one of the foregoing conditions. Preferably, for shipping economy, space, and the like, the carpet is in the form of bales that can comprise any number of different types of PET, polypropylene, or nylon carpets, e.g., different carpet origins, physical properties, chemical properties, and the like. Unlike many carpet recycling methods, the carpet can be unseparated, i.e., carpet that has not been modified to remove or separate out one or more of the primary components (pile, backing, adhesive, etc.) from the carpet prior to processing. Although an unseparated bulk carpet sample is preferred, separated carpet, or portions thereof can be employed in the present process. In other words, if the backing, for example, has been reclaimed in another process, the pile and other remaining carpet components can be employed.

Typically, the carpet will comprise pile, a backing, an adhesive, and a filler. The pile and the backing often comprises a thermoplastic material, such as a polyolefin, polyester, polypropylene, nylon, and the like, as well as combinations comprising at least one of the foregoing materials. The adhesive typically employed to adhere the pile to the backing typically comprises a latex material, other adhesives, and the like. Some possible adhesives include styrene-butadiene rubber (SBR), acrylate resins, polyvinyl acetate, and the like, as well as combinations comprising at least one of the foregoing adhesives. Finally, the filler comprises calcium carbonate.

Typically, a carpet can comprise a main material and optionally, latex, flame retardants, additives, and the like. Generally, the carpet comprises greater than or equal to about 50 weight percent (wt %) of the main material (e.g., PET, polypropylene, nylon, or the like), with greater than or equal to about 70 wt % main material preferred, and greater than or equal to about 80 wt % main material more preferred, based on the total weight of the carpet excluding water weight. The carpet typically also comprises greater than or equal to about 5 wt % latex material, may comprise up to about 20 wt % or so of a flame retardant, and may comprise about 0.5 wt % to about 10 wt % calcium carbonate. In an exemplary embodiment, a carpet comprises, about 80 wt % to about 85 wt % main material (e.g., PET, polypropylene, nylon, or the like), about 10 wt % to about 15 wt % latex material, and less than or equal to about 10 wt % calcium carbonate, based on the total weight of the carpet excluding water weight.

In order to attain a desired, and preferably consistent, product from the recycling, various additives can be added to the carpet. The amounts and types of additives employed are based upon the composition of the carpet. Generally, one or more bales, from a truck load of carpet bales, are tested for composition utilizing a spectrometer to determine composition, and melt index is determined to clarify the amount of additives preferred. Generally, greater than or equal to about 0.3 wt % additives are added to the carpet, with greater than or equal to about 0.5 wt % preferred, with greater than or equal to about 1 wt % more preferred based upon the total weight of the carpet and additives combined (e.g., the total combined weight). Also preferred is to employ less than or equal to about 40 wt % additives, with less than or equal to about 20 wt % preferred, less than or equal to about 10 wt % more preferred, and less than or equal to about 5 wt % even more preferred, based upon the total weight of the carpet and additives combined.

The additives may comprise colorants, stabilizers (e.g., light stabilizers, heat stabilizers, and others), delusterants, flame-retardants (e.g., ATH, and the like), fillers, antimicrobial agents, antistatic agents, optical brighteners, extenders, processing aids, compatibilizers, flow enhancers, mold release agents, UV absorbers, lubricants, plasticizers, pigments, dyes, blowing agents, impact modifiers, and other additives that impart desired properties to the product. Some possible additives include impact modifiers such as olefin-containing copolymers (e.g., olefin acrylates such as ethylene ethylacrylates, and the like; olefin diene terpolymers, such as ethylene propylene dienes (EPDM), and the like), and polyolefins (e.g., polyethylene, polyethylene copolymers with alpha-olefins); and the like, as well as combinations comprising at least one of the foregoing impact modifiers, with EPDM preferred. Possible flow enhancers include polyesters, e.g., poly(1,4-butylene terephthalate) (PBT), poly(propylene terephthalate) (PPT), poly(ethylene terephthalate) (PET), and the like, as well as combinations comprising at least one of the foregoing flow enhancers. Preferred additives comprise PET, which is usable with polypropylene and nylon at about 2 wt % to about 5 wt %, based upon the total combined weight, and EPDM, which is employed at an amount of about 5 wt % to about 10 wt % based upon the total combined weight.

Fillers, such as anhydrous aluminum silicates, mica, feldspar, clays, talc, glass (e.g., flake, fibers, microspheres, nanotubes, and the like), wollastonite, metal oxides (e.g., alumina, titanium dioxide, silica, zinc oxide, and the like), zinc sulfide, ground quartz, barium sulfate, fiberglass, and the like, as well as combinations comprising at least one of the foregoing fillers, can be employed to attain a desired thermal stability, density, stiffness, and texture. Preferred fillers include clays, talc, calcium carbonate, and combinations comprising at least one of these fillers in amounts of about 5 wt % to about 10 wt %, based upon the total combined weight. The amount and type of additive added to either the carpet/carpet strips/melted carpet ultimately depends upon the composition of the carpet, and the use of the product. Preferably, the carpet is formed into pellets that are useful in injection molding plastic articles (e.g., pallets, chambers, end-plates, and the like).

Processing of the carpet comprises optionally introducing the carpet to a shredder. Within the shredder the carpet sample is shredded to a size compatible with the other system machinery. Typically, the carpet is shredded into strips of up to about 3 inches by up to about 12 inches. This is done because it is difficult to shred carpet any finer without multiple passes through the shredder. The carpet is passed through the shredder only once and some material is finely shred and some is in longer strips. The continuous mixer allows for the use of longer strips without plugging up the machine. Shredding it only once makes it more cost effective.

From the shredder, the carpet strips enter a continuous mixer where the strips are preferably melted. Additionally, if the water content of the carpet strips is greater than about 0.5 wt %, the water content is reduced to less than or equal to about 0.5 wt %, based upon the total weight of the carpet (including the water). The melting and mixing can be preformed in any continuous mixer capable of attaining sufficient temperatures to melt the carpet and vaporize and vent the water. For example, after shredding, the carpet strips are directed to a Farrel or Technical Process & Engineering continuous mixer 5 via a conveyor 3 and hopper 4. Within the mixer 5, the carpet is melted and its moisture content is reduced to less than or equal to about 0.5 wt % to form melted carpet ribbon. Optionally, some additives are introduced at this stage as well, e.g., impact modifiers such as EPDM and the like. Due to this processing, and the reduction of water content to less than or equal to about 0.5 wt % prior to introduction to the extruder, the process allows the recycling of carpet that can be saturated with water (e.g., that was in the rain).

From the mixer 5, the melted carpet is introduced to an extruder 6. Extruders capable of melting and mixing the melted carpet and preferably of receiving additional components downstream of the carpet introduction point can be employed. Possible extruders include twin and single screw extruders, as well as others. Within or prior to the extruder 6, additive(s) may optionally be introduced to the carpet, e.g., introduced to the strips in or prior to the mixer 5, introduced to the melted carpet in the mixer 5 or at the melted carpet inlet of the extruder 6, and/or downstream from the melted carpet inlet of the extruder 6. Within the extruder 6, which is maintained at a temperature sufficient to melt mix the various components (e.g., carpet, additives, and the like), the components are preferably homogenously combined to form a melted mixture.

At the end of the extruder 6, the melted mixture can be formed into pellets by various pelletizing operations. For example, the melted mixture can pass through a die 10 and chopper (not shown). Alternatively, an underwater pelletizer 11 can be employed to form the extruded mixture into pellets. The pellets can be employed alone or in combination with other materials (e.g., virgin PET, polypropylene, and/or nylon) in various molding processes such as, but not limited to, blow molding, injection molding (e.g., high pressure injection, gas assist, structural foam, and the like), thermoforming (e.g., pressure forming, vacuum forming, stamping, and the like), extrusion (e.g., sheet extrusion, film extrusion, geometric shape (e.g., pipes and the like) extrusion), and the like.

For example, first each truckload has a sampling of bales of carpet analyzed to determine it's material content, moisture levels and melt index to enable a determination of the types and amounts of additives and fillers. Then the carpet is shredded into strips no larger than about 3 inches (7.62 centimeters (cm)) by about 12 inches (30.48 cm), and fed via a conveyer into the mixer along with flow enhancers (e.g., about 5 wt % to about 25 wt % EPDM is added, based upon the total combined weight, depending upon the carpet composition). The carpet and flow enhancers are mixed and heated to about 350° F. (about 177° C.) to about 450° F. (about 232° C.) to melt and blend the materials as well as remove moisture to less than or equal to about 0.5%. The melt ribbon is then fed directly into the throat of the extruder where additional additives are also optionally added. At the throat of the extruder, about 2 wt % to about 5 wt % PET, and about 1 wt % to about 5 wt % calcium carbonate, and possibly other additives are introduced to the melt ribbon, based upon the total combined weight (inclusive of water weight). The extruder then blends and melts this mixture (e.g., at about 450° F. (about 232° C.) to about 550° F. (about 288° C.)) and extrudes it through a water ring pelletizer at rates typically, but not limited to, about 5,000 to about 10,000 pounds per hour (lb/hr) depending on factors including feedstock density and equipment size. The recycle material can then be employed in a molding process including injection molding (high pressure, gas assist, structural foam, and the like), blow molding, sheet extrusion, and the like, to form various articles. Some possible articles include, leaching chambers, pallets, endplates, as well as various other PET, polypropylene, or nylon products.

Employing the recycle material in a molding process can comprise melting the pellets. The pellets can optionally be combined with virgin material(s) and/or non-carpet originated recycled material(s) prior to, during, or after melting the pellets. The molten material can then be introduced into a mold having a negative of the article to be formed. The molten material is cooled (actively or passively) to form the article. Alternatively, a parison can be formed from the pellets and optionally combined with virgin material(s) and/or non-carpet originated recycled material(s). The parison is disposed between mold halves and one end of the parison is closed. An inert gas is then blown into the parison to form a balloon and the mold halves are closed to form an article.

### EXAMPLES

### Example 1

A truckload of bales of carpet is randomly sampled (e.g., 3 bales are selected from the truckload and some material from each of the 3 bales is analyzed for material composition, content and melt index). For example, the load can consist of polypropylene carpet comprising 84 wt % polypropylene, 11 wt % latex, and the balance was calcium carbonate, with a moisture content of averaging 8 wt % and the melt index of 3. The bales are then shredded to allow the material to be fed into the mixer. Based on compositional analysis, EPDM (e.g., 10 wt %) can be added to the carpet at the feed throat of a continuous mixer. The material can be processed in the continuous mixer at 380° F. into a homogeneous blend of carpet and EPDM, while driving off excess water content (via converting water to steam and venting out of mixer) until residual water content is less than 0.5%. The blend can then be fed directly into the feed throat of an extruder along with 3 to 7 wt % PET and processed at 450° F. to further mix and blend the materials for introduction to a water ring pelletizer for conversion to pellets.

### Example 2

An endplate for use with a leaching chamber for dispersing liquids in soil, of the type having a hollow inter with open ends, and sidewalls with perforations enabling passage of liquids therethrough can be formed using the recycled carpet. The recycled carpet can be melted without separating various carpet layers. Water content of the carpet entering the continuous mixer can be up to about 10 wt %. The water content of the recycled carpet is reduced to less than or equal to about 0.5 wt % within the continuous mixer, based upon the total weight of the recycle carpet and the water, as discussed in Example 1, to form a melt ribbon. The melt ribbon, being properly screened for contaminant elimination, is mixed with an additive, e.g., in an extruder, kneader, or the like, to form a parison. The parison is disposed, e.g., extruded, between mold halves and one end of the parison is closed. An inert gas is then blown into the parison to form a balloon and the mold halves are closed to form the endplate. The endplate can comprise any appropriate endplate geometry, e.g., an inner wall and an outer wall defining a central portion having an interior channel, and at least one connector disposed about the periphery of the central portion, the connector capable of engaging the leaching chamber.

### Example 3

Leaching chamber for dispersing liquids in soil, of the type having a hollow interior with open ends and an open bottom enabling passage of liquids therethrough can be formed from the melt ribbon or the pellets of recycled carpet. The recycle carpet can be melted without separating various carpet layers. The water content of the recycle carpet can be reduced to less than or equal to about 0.5 wt %, based upon the total weight of the recycle carpet and the water, by converting excess water to steam and venting the steam out of mixer. The water reduced material is then feed into an extruder. An additive can be mixed with the melt ribbon to form a mixture that is extruded to form pellets. The pellets can be heated to melting and introduced to a mold having a negative of the leaching chamber. Once the melt has cooled, actively or passively, the leaching chamber can be removed from the mold.

### Example 4

A plastic article can be produced by extruding flat sheet manufactured from melt ribbon or the pellets of recycled carpet and then creating the article geometry through the thermoforming or stamping manufacturing process. The pellets can first be produced as per Example 1. The pellets or melt ribbon is feed through a sheet extrusion line having an extruder to melt the pellets (or ribbon), sheet die (for melt distribution to form sheet), calendaring stack (flattens, calendars, sizes sheet, initiates cooling), cooling stage (typically a water bath), and a cut-off station or take-up roll (depending on sheet thickness or end use). The sheet is then heated and formed by drawing (vacuum thermoforming), pushing (pressure thermoforming), or compressing (stamping) the sheet over a tool containing the negative of the plastic article geometry. Once the melt has cooled, actively or passively, the plastic article can be removed from the mold. This process can be employed to form a plastic pallet or component thereof.

The recycle pellets formed from recycling the carpet can be employed to form various injection molded articles, including, leaching chambers, pallets, endplates, and the like. The recycle pellets, which may or may not comprise additives, can be combined with virgin material, such as polypropylene, high density polypropylene, PET, nylon, and the like (e.g., noncarpet recycle). In this embodiment, the recycle pellets can be employed to form an article, in an amount of about 0.1 wt % to about 100 wt % recycle material (i.e., the pellet reformed into the desired article), based on the total weight of the article. The specific amount of the recycle material will depend upon the requirements of the actual article. For example, for a leaching chamber, endplate, and the like, greater than or equal to 50 wt % recycle material can be employed, with greater than or equal to about 75 wt % recycle material preferred, greater than or equal to about 90 wt % recycle material more preferred, and greater than or equal to about 95 wt % recycle material especially preferred. In contrast, for a pallet (e.g., a plastic pallet), about 5 wt % to about greater than or equal to 40 wt % recycle material can be employed. Within this range, greater than or equal to about 10 wt % recycle material is preferred, with greater than or equal to about 15 wt % recycle material is more preferred. Also preferred is less than or equal to about 30 wt % recycle material is preferred, with less than or equal to about 25 wt % recycle material more preferred.

Injection molding of recycled polypropylene carpet has not previously been successful due to: 1) water content of the carpet, 2) the perceived need to produce pure polypropylene pellets, thus requiring significant separation of materials, and 3) the recycled carpet's fractional melt index (e.g., polypropylene used to make carpet fibers typically has a melt index of less than 2). While fractional melts are desired for some molding processes such as sheet extrusion (melt range typically from fractional up to 4), fractional melts are not desirable for blow molding (typical melt index of 2 to 6) and injection molding (typical melt index of greater than about 6). It has been discovered that by reducing the water content and blending the right amount of additives to alter the melt index, appropriate pellets can be formed even from recycled carpet that has not been separated into its various constituents (e.g., pile, adhesive, backing, etc.). Preferably the water content is reduced to less than 2 wt %, with a reduction to a water content of less than or equal to about 0.5 wt % water more preferred.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention.

1. A method for recycling carpet, comprising:
melting recycle carpet;
reducing a water content of the recycle carpet to less than or equal to about 0.5 wt %, based upon the total weight of the recycle carpet and the water, to form a melt ribbon; and
forming pellets from the extruded melt ribbon of recycle material.

2. The method as in claim 1, wherein the recycle carpet is melted without separating various carpet layers.

3. The method as in claim 1, wherein the carpet further comprises greater than or equal to about 50 wt % of a main material selected from the group consisting of PET, polypropylene, and nylon, based upon the total weight of the recycle carpet, excluding any water.

4. The method as in claim 3, wherein the carpet further comprises greater than or equal to about 5 wt % latex material and comprises greater than or equal to about 70 wt % of the main material.

5. The method as in claim 4, wherein the carpet comprises greater than or equal to about 80 wt % of the main material, based upon the total weight of the recycle carpet, excluding any water.

6. The method as in claim 5, wherein the carpet comprises about 80 wt % to about 85 wt % of the main material, about 10 wt % to about 15 wt % latex material, and less than or equal to about 10 wt % calcium carbonate.

7. The method as in claim 1, wherein the melt ribbon is mixed with about 0.5 wt % to about 40 wt % additive, based upon the total weight of the recycle carpet and additive, excluding any water.

8. The method as in claim 7, wherein the melt ribbon is mixed with about 3 wt % to about 20 wt % additive.

9. The method as in claim 8, wherein the melt ribbon is mixed with about 5 wt % to about 10 wt % additive.

10. The method as in claim 7, wherein the additive comprises a filler selected from the group consisting of clay, talc, calcium carbonate, and combinations comprising at least one of the foregoing fillers.

11. The method as in claim 7, wherein the additive further comprises about 2 wt % to about 5 wt % PET, and about 1 wt % to about 5 wt % calcium carbonate.

12. The method as in claim 1, further comprising introducing the melt ribbon to an extruder, mixing the melt ribbon with the additive in the extruder, and extruding the mixture to form the pellets.

13. The method as in claim 1, further comprising combining the pellets with a second material to form a mixture and molding the mixture to form an article, wherein the second material is selected from the group consisting of virgin material and non-carpet originated recycled material, and combinations thereof.

14. The method as in claim 1, further comprising melting the pellets, forming an article by disposing the melted pellets in a mold having a negative of the article; and removing the article from the mold.

15. The method as in claim 14, wherein the article is a leaching chamber for dispersing liquids in soil, of the type having a hollow interior with open ends and an open bottom enabling passage of liquids therethrough.

16. The method as in claim 15, wherein the leaching chamber comprises greater than or equal to about 90 wt % recycle material, based upon the total weight of the leaching chamber.

17. The method as in claim 14, wherein the article is a pallet comprising a second material and about 5 wt % to about 40 wt % recycle material, based upon the total weight of the pallet, wherein the second material is selected from the group consisting of virgin material and non-carpet originated recycled material, and combinations thereof.

18. The method as in claim 17, wherein the pellet comprises about 15 wt % to about 25 wt % recycle material.

19. The method as in claim 1, further comprising:
forming a parison;
disposing the parison between mold halves;
closing an end of the parison;
blowing an inert gas into the parison to form a balloon; and
closing the mold halves to form an article.

20. The method as in claim 19, wherein the article is an endplate for use with a leaching chamber for dispersing liquids in soil, of the type having a hollow interior with open ends, and sidewalls with perforations enabling passage of liquids therethrough, and wherein the endplate comprises an inner wall and an outer wall defining a central portion having an interior channel.

21. The method as in claim 20, wherein the endplate further comprises at least one connector, the connector capable of engaging the leaching chamber on an inner surface and an outer surface.

22. The method as in claim 20, wherein the endplate comprises greater than or equal to about 90 wt % recycle material, based upon the total weight of the endplate.

23. An article formed from the method of claim 21.

24. The method as in claim 1, further comprising melting the pellets and molding the melted pellets to form an article, wherein the molding is selected from the group consisting of blow molding, injection molding, thermoforming, extrusion, and combinations thereof.

25. An article formed from injection molding the pellets of claim 1.

26. The article as in claim 24, wherein the article is selected from the group consisting of leaching chambers, and endplates.

27. The article as in claim 24, wherein the article comprises a pallet.
